(19) United States
(12) Patent Application Publication
(10) Pub. No.: US 2024/0308135 A1
(43) Pub. Date: Sep. 19, 2024

(54) THREE-DIMENSIONAL SHAPING METHOD AND THREE-DIMENSIONAL SHAPING APPARATUS

(71) Applicant: SEIKO EPSON CORPORATION, Tokyo (JP)

(72) Inventors: Manabu WATANABE, SHIOJIRI-SHI (JP); Akihiko TSUNOYA, OKAYA-SHI (JP)

(21) Appl. No.: 18/604,038

(22) Filed: Mar. 13, 2024

(30) Foreign Application Priority Data
Mar. 14, 2023 (JP) 2023-039598

(51) Int. Cl. B29C 64/165; B29C 64/209; B29C 64/218; B29C 64/295; B33Y 10/00; B33Y 70/10

(52) U.S. Cl. CPC B29C 64/165; B29C 64/209; B29C 64/218; B29C 64/295; B33Y 10/00; B33Y 70/10

(57) ABSTRACT

A three-dimensional shaping method includes a shaping step including: a first step of supplying a powder containing a plant-derived fiber material to form a powder layer; a second step of dispensing at least one of a first liquid or a second liquid to at least a part of the powder layer, the first liquid containing both a binder and an infrared absorber, the second liquid containing at least the binder among the binder and the infrared absorber; and a third step of heating the powder layer to which a liquid is dispensed in the second step at a predetermined heating temperature. The heating temperature is lower than a boiling point of the binder and higher than a melting point of the binder. A content of the infrared absorber in the second liquid is lower than a content of the infrared absorber in the first liquid.

The present application is based on, and claims priority from JP Application Serial Number 2023-039598, filed Mar. 14, 2023, the disclosure of which is hereby incorporated by reference herein in its entirety.

### BACKGROUND

### 1. Technical Field

The present disclosure relates to a three-dimensional shaping method and a three-dimensional shaping apparatus.

### 2. Related Art

Research and development are carried out on a three-dimensional shaping apparatus that shapes a three-dimensional shaped object by stacking powder layers of a powder containing a metal powder and the like.

Here, in such a three-dimensional shaping apparatus, the powder layers are formed. Each time a powder layer is formed, a liquid containing a binder is dispensed to at least a part of the powder layer, and the powder layer to which the liquid is dispensed is heated. Accordingly, the three-dimensional shaping apparatus melts the powder in a region to which the liquid is dispensed in a region of the powder layer to shape the three-dimensional shaped object.

In this regard, there is known a three-dimensional shaping method for shaping a three-dimensional shaped object by stacking powder layers. The three-dimensional shaping method includes: a powder layer forming step of forming a powder layer by using a powder including a plurality of particles each including a base part and a surface layer formed of a thermoplastic resin; a temporary bonding step of heating the powder layer to temporarily bond the particles contained in the powder; and a binding liquid applying step of applying a binding liquid including a binder for forming a bound part to the heated powder layer (see JP-A-2016-187943).

JP-A-2016-187943 is an example of the related art.

Here, there is a demand for forming a predetermined texture at a surface of the three-dimensional shaped object after shaping. However, when the texture is to be formed at the surface of the three-dimensional shaped object by using the three-dimensional shaping method disclosed in JP-A-2016-187943, it is necessary to prepare a plurality of binding liquids having different colors and use different ones among the plurality of binding liquids for each portion to which the binding liquid is applied. The number of the plurality of binding liquids to be prepared increases as the number of colors in the texture to be formed at the surface of the three-dimensional shaped object increases. This leads to an increase in the number of printer heads that dispense a binding agent in the three-dimensional shaping apparatus that shapes the three-dimensional shaped object, which is not preferable. There is also known a method of applying a color to a surface of a three-dimensional shaped object as another method for forming a texture at the surface of the three-dimensional shaped object. However, the method is not preferable because the more complex the shape of the three-dimensional shaped object is, the more difficult it becomes to accurately form the texture at the surface of the three-dimensional shaped object.

### SUMMARY

To solve the above problems, one aspect of the present disclosure is a three-dimensional shaping method for shaping a three-dimensional shaped object. The three-dimensional shaping method includes: a shaping step of shaping the three-dimensional shaped object by repeating at least a first step and a second step among three steps including the first step, the second step, and a third step. The first step is supplying a powder containing a plant-derived fiber material to form a powder layer on a shaping surface at which the three-dimensional shaped object is to be shaped. The second step is dispensing at least one of a first liquid or a second liquid to at least a part of the powder layer formed in the first step, the first liquid containing both a binder and an infrared absorber, the second liquid containing at least the binder among the binder and the infrared absorber. The third step being heating the powder layer to which at least one of the first liquid or the second liquid is dispensed in the second step at a predetermined heating temperature. The heating temperature is lower than a boiling point of the binder and higher than a melting point of the binder. A content of the infrared absorber in the second liquid is lower than a content of the infrared absorber in the first liquid.

In addition, to solve the above problems, one aspect of the present disclosure is a three-dimensional shaping apparatus for shaping a three-dimensional shaped object. The three-dimensional shaping apparatus includes: a shaping table having a shaping surface for shaping the three-dimensional shaped object; a layer formation unit configured to form a powder layer of a powder containing a plant-derived fiber material above the shaping surface; a dispensing unit configured to dispense at least one of a first liquid or a second liquid to at least a part of the powder layer formed by the layer formation unit, the first liquid containing both a binder and an infrared absorber, the second liquid containing at least the binder among the binder and the infrared absorber; a heating unit configured to heat the powder layer to which at least one of the first liquid or the second liquid is dispensed by the dispensing unit; and a control unit configured to control the dispensing unit, the layer formation unit, and the heating unit. The control unit heats the powder layer at a predetermined heating temperature when the powder layer is heated by the heating unit, the heating temperature is lower than a boiling point of the binder and higher than a melting point of the binder, and a content of the infrared absorber in the second liquid is lower than a content of the infrared absorber in the first liquid.

### BRIEF DESCRIPTION OF THE DRAWINGS

FIG. 1 is a view illustrating an example of a configuration of a three-dimensional shaping apparatus 1.

FIG. 2 is a diagram illustrating an example of a state in which a powder layer L2 among four powder layers illustrated in FIG. 1 is formed by a shaping unit 20.

FIG. 3 is a diagram illustrating an example of a flow of a three-dimensional shaping method in which a user shapes a three-dimensional shaped object by using the three-dimensional shaping apparatus 1.

### DESCRIPTION OF EMBODIMENTS

### Embodiment

In the following description, an embodiment of the present disclosure will be described with reference to the drawings.

### Overview of Three-Dimensional Shaping Method

First, an overview of a three-dimensional shaping method according to the embodiment will be described.

The three-dimensional shaping method according to the embodiment is a method for shaping a three-dimensional shaped object. More specifically, the three-dimensional shaping method includes a shaping step. The shaping step includes a first step, a second step, and a third step, and is a step of shaping the three-dimensional shaped object by repeating at least the first step and the second step among three steps including the first step, the second step, and the third step. Here, the first step is supplying a powder containing a plant-derived fiber material to form a powder layer above a shaping surface at which the three-dimensional shaped object is shaped. The second step is dispensing at least one of a first liquid or a second liquid to at least a part of the powder layer formed in the first step. The first liquid includes both a binder and an infrared absorber. The second liquid includes at least the binder among the binder and the infrared absorber. The third step is heating the powder layer to which at least one of the first liquid or the second liquid is dispensed in the second step at a predetermined heating temperature. The heating temperature is lower than a boiling point of the binder and higher than a melting point of the binder. Further, a content of the infrared absorber in the second liquid is lower than a content of the infrared absorber in the first liquid. Accordingly, in the three-dimensional shaping method, for example, a multicolor texture can be formed at a surface of the three-dimensional shaped object by changing a ratio of an amount of the dispensed first liquid and an amount of the dispensed second liquid for each region to which the liquid is dispensed in the powder layer. As a result, in the three-dimensional shaping method, a desired texture can be formed at the surface of the three-dimensional shaped object without increasing the number of members for dispensing the liquid in the three-dimensional shaping apparatus that shapes the three-dimensional shaped object using the plant-derived fiber material.

In the following description, a configuration of the three-dimensional shaping apparatus capable of executing the three-dimensional shaping method according to the embodiment and processing performed by the three-dimensional shaping apparatus will be described to describe the three-dimensional shaping method in detail.

### Structure of Three-Dimensional Shaping Apparatus

In the following description, the configuration of the three-dimensional shaping apparatus capable of executing the three-dimensional shaping method according to the embodiment will be described by taking a three-dimensional shaping apparatus 1 as an example.

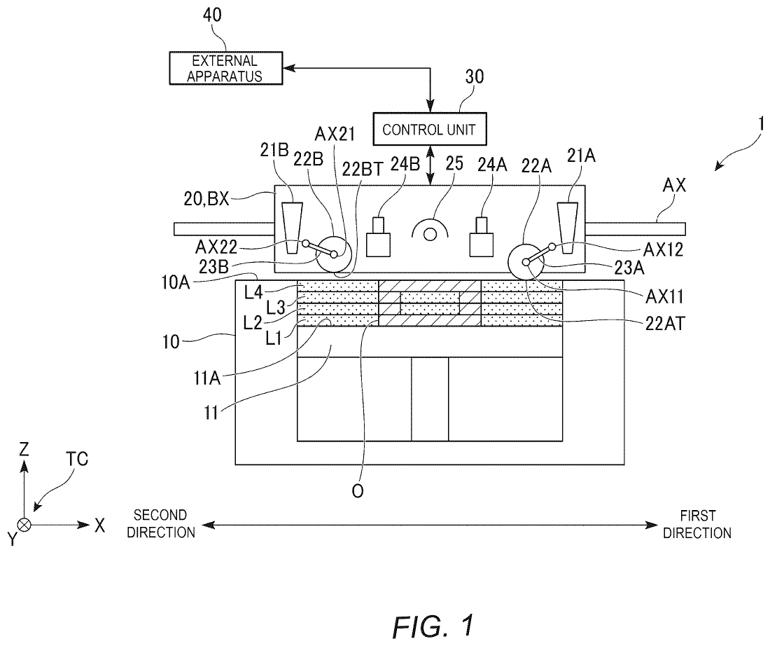

FIG. 1 is a view illustrating an example of a configuration of the three-dimensional shaping apparatus 1.

Here, a three-dimensional coordinate system TC is a three-dimensional orthogonal coordinate system indicating directions in the drawing in which the three-dimensional coordinate system TC is drawn. In the following description, for convenience of description, an X axis in the three-dimensional coordinate system TC will be simply referred to as an X axis. In the following description, for convenience of description, a Y axis in the three-dimensional coordinate system TC will be simply referred to as a Y axis. In the following description, for convenience of description, a Z axis in the three-dimensional coordinate system TC will be simply referred to as a Z axis. Further, in the following description, for example, a case where a negative direction of the Z axis coincides with a gravity direction will be described. Therefore, in the following description, for convenience of description, a positive direction of the Z axis is simply referred to as above or upward, and the negative direction of the Z axis will be referred to as below or downward.

The three-dimensional shaping apparatus 1 is an apparatus that shapes a three-dimensional shaped object by stacking N powder layers of a powder containing a plant-derived fiber material. The N may be any integer of 1 or more. In the following description, for convenience of description, an n-th powder layer from a bottom among the N powder layers stacked by the three-dimensional shaping apparatus 1 will be referred to as an n-th powder layer. The n is any integer within a range of 1 or more and N or less. That is, a shaping unit 20 forms the n-th powder layer above an (n-1)-th powder layer. In this case, a 0th powder layer indicates the shaping surface at which the three-dimensional shaped object is shaped by the three-dimensional shaping apparatus 1. The plant-derived fiber material is, for example, a lignocellulosic material. The lignocellulosic material is, for example, a material of a fiber collected from a bast of a hemp plant such as kenaf, flax, ramie, cannabis, and jute. Further, the lignocellulosic material is, for example, a material of a fiber collected from a stem or a leaf vein of a hemp plant such as Manila hemp and sisal hemp. Further, the lignocellulosic material is, for example, a wood fiber material using a conifer, a broad-leaved tree, or the like as a raw material. The lignocellulosic material is not limited thereto. The plant-derived fiber material may be other plant-derived fiber materials instead of a lignocellulosic material. In the following description, for example, a case where the plant-derived fiber material is a lignocellulosic material will be described. In the following description, for convenience of description, the powder containing a lignocellulosic material will be referred to as a powder P. The powder P may contain other materials in addition to the lignocellulosic material. In the following description, for example, a case where the powder P contains a lignocellulosic material and does not contain other materials will be described.

The three-dimensional shaping apparatus 1 includes, for example, a table unit 10, the shaping unit 20, and a control unit 30. The three-dimensional shaping apparatus 1 is communicably connected to an external apparatus 40. The three-dimensional shaping apparatus 1 may include the external apparatus 40 or may be configured integrally with the external apparatus 40. In addition to the table unit 10, the shaping unit 20, and the control unit 30, the three-dimensional shaping apparatus 1 may include other members, other devices, and the like. The three-dimensional shaping apparatus 1 may not include the control unit 30. In this case, the three-dimensional shaping apparatus 1 is communicably connected to an apparatus corresponding to the control unit 30.

The table unit 10 includes a shaping table 11. The table unit 10 is controlled by, for example, the control unit 30. The table unit 10 may be controlled by another information processing apparatus such as the external apparatus 40 instead of being controlled by the control unit 30.

The shaping table 11 is a member having a shaping surface 11A. The shaping surface 11A is an example of the shaping surface at which the three-dimensional shaped object is shaped by the three-dimensional shaping apparatus 1. That is, the shaping surface 11A is a surface at which the above-described N powder layers are stacked among surfaces of the shaping table 11.

The table unit 10 moves the shaping table 11 up and down relative to an upper surface 10A of the table unit 10 under the control from the control unit 30. Therefore, the shaping surface 11A moves up and down relative to the upper surface 10A as the shaping table 11 moves up and down. That is, the shaping surface 11A moves upward relative to the upper surface 10A as the shaping table 11 moves upward. The shaping surface 11A moves downward relative to the upper surface 10A as the shaping table 11 moves downward. The table unit 10 includes an actuator and the like as various members that move the shaping table 11 up and down. However, in FIG. 1, the various members are omitted to prevent the drawings from being complicated.

More specifically, when the three-dimensional shaping apparatus 1 is to form a first powder layer above the shaping surface 11A, the table unit 10 moves the shaping table 11 such that the shaping surface 11A is located below the upper surface 10A of the table unit 10 by a thickness of the first powder layer in response to a request from the control unit 30. Accordingly, the three-dimensional shaping apparatus 1 forms the first powder layer above the shaping surface 11A by the shaping unit 20 to be described later. Further, when the three-dimensional shaping apparatus 1 is to form the n-th powder layer above the (n-1)-th powder layer, the table unit 10 moves the shaping table 11 such that an upper surface of the (n-1)-th powder layer is located below the upper surface 10A by a thickness of the n-th powder layer in response to the request from the control unit 30. The thickness of the n-th powder layer is a thickness of the n-th powder layer in a gravity direction.

Four powder layers including powder layers L1 to L4 are stacked above the shaping surface 11A illustrated in FIG. 1. The powder layer L1 is an example of the first powder layer. The powder layer L2 is an example of a second powder layer. The powder layer L3 is an example of a third powder layer. The powder layer L4 is an example of a fourth powder layer.

The shaping unit 20 is a device that shapes the three-dimensional shaped object by stacking the N powder layers above the shaping surface 11A of the shaping table 11. A three-dimensional shaped object O illustrated in FIG. 1 is an example of the three-dimensional shaped object shaped by stacking the above-described powder layers L1 to L4 above the shaping surface 11A by the shaping unit 20.

The shaping unit 20 includes, for example, a guide bar AX, a body portion BX, a first supply unit 21A, a first layer formation unit 22A, a first swinging unit 23A, a first dispensing unit 24A, a second supply unit 21B, a second layer formation unit 22B, a second swinging unit 23B, a second dispensing unit 24B, and a heating unit 25. The shaping unit 20 may include other members, other devices, and the like in addition to the guide bar AX, the body portion BX, the first supply unit 21A, the first layer formation unit 22A, the first swinging unit 23A, the first dispensing unit 24A, the second supply unit 21B, the second layer formation unit 22B, the second swinging unit 23B, the second dispensing unit 24B, and the heating unit 25. The shaping unit 20 may not include either the first supply unit 21A or the second supply unit 21B. The shaping unit 20 may not include either the first layer formation unit 22A or the second layer formation unit 22B. Here, when the shaping unit 20 does not include the first layer formation unit 22A, the shaping unit 20 does not include the first swinging unit 23A. When the shaping unit 20 does not include the second layer formation unit 22B, the shaping unit 20 does not include the second swinging unit 23B. Further, the shaping unit 20 may not include either the first dispensing unit 24A or the second dispensing unit 24B.

The guide bar AX is a shaft body provided in the three-dimensional shaping apparatus 1 to be parallel to a predetermined first direction. In the following description, for example, a case as illustrated in FIG. 1 where the first direction coincides with a positive direction of the X axis will be described.

The body portion BX includes a housing that houses the first supply unit 21A, the first layer formation unit 22A, the first swinging unit 23A, the first dispensing unit 24A, the second supply unit 21B, the second layer formation unit 22B, the second swinging unit 23B, the second dispensing unit 24B, and the heating unit 25. The housing is open downward. The body portion BX reciprocates back and forth along the guide bar AX in the first direction in response to the request from the control unit 30. The body portion BX includes an actuator and the like as various members that move the body portion BX along the guide bar AX. However, in FIG. 1, the various members are omitted to prevent the drawings from being complicated.

The first supply unit 21A is a device that supplies the powder P downward. The first supply unit 21A is provided at a head-side end portion of the body portion BX in the first direction. The first supply unit 21A includes a nozzle (not illustrated), and dispenses the powder P, which is supplied from a storage unit (not illustrated) that stores the powder P, downward from a tip of the nozzle. Accordingly, the first supply unit 21A can supply the powder P above the shaping surface 11A of the shaping table 11. For example, when the body portion BX moves in the first direction along the guide bar AX, the first supply unit 21A dispenses the powder P downward.

The first layer formation unit 22A is a member that forms the powder layer by smoothing the powder P supplied by the first supply unit 21A. The first layer formation unit 22A is provided adjacent to the first supply unit 21A in a second direction in the body portion BX. In the example illustrated in FIG. 1, the first layer formation unit 22A is a roller that rotates about a rotation shaft AX11, and forms the powder layer above the shaping surface 11A by pressing and smoothing the powder P supplied above the shaping surface 11A of the shaping table 11 from above. Instead of the roller, the first layer formation unit 22A may be another member capable of pressing and smoothing the powder P supplied above the shaping surface 11A of the shaping table 11 from above, such as a squeegee. The first layer formation unit 22A is supported by the first swinging unit 23A swingable about a predetermined swinging shaft AX12. More specifically, the rotation shaft AX11 of the first layer formation unit 22A is supported by the first swinging unit 23A swingable about the swinging shaft AX12. When the body portion BX moves in the first direction along the guide bar AX, the first layer formation unit 22A is located at a position where a lower end 22AT of the first layer formation unit 22A comes into contact with a virtual surface including the upper surface 10A of the table unit 10. In contrast, when the body portion BX moves in the second direction opposite to the first direction along the guide bar AX, the first layer formation unit 22A is located at a position where the lower end 22AT of the first layer formation unit 22A is separated upward from the surface. Such movement of the first layer formation unit 22A is implemented by the first swinging unit 23A.

The first swinging unit 23A is a rod-shaped member that supports the rotation shaft AX11 of the first layer formation unit 22A. The first swinging unit 23A can swing about the swinging shaft AX12 by an actuator (not illustrated) or the like. Accordingly, the first swinging unit 23A can separate the first layer formation unit 22A from the virtual surface including the upper surface 10A of the table unit 10.

The first dispensing unit 24A is a liquid dispensing device that dispenses a first liquid X1 containing both the binder and the infrared absorber downward, and is, for example, a printer head having an adjustable dispensing amount of the first liquid X1 per unit time. The infrared absorber may be any object that generates heat by absorbing infrared rays, and is, for example, carbon. The infrared absorber may contain other substances in addition to carbon. When the infrared absorber is carbon, a color of the infrared absorber is black. When the infrared absorber is an object other than carbon, the color of the infrared absorber may be a color other than black. The first dispensing unit 24A is provided adjacent to the first layer formation unit 22A in the second direction in the body portion BX. The first dispensing unit 24A may be a printer head having an unadjustable dispensing amount of the first liquid X1 per unit time. The first dispensing unit 24A includes a plurality of nozzles (not illustrated) arranged in the first direction and a direction orthogonal to the gravity direction. In response to the request from the control unit 30, the first dispensing unit 24A dispenses the first liquid X1, which is supplied from a storage unit (not illustrated) that stores the first liquid X1, downward from at least a part of the plurality of nozzles. Accordingly, the first dispensing unit 24A can dispense the first liquid X1 to at least a part of a predetermined shaping region for each powder layer.

Here, the powder layer includes the shaping region that is at least a part of the three-dimensional shaped object and a non-shaping region that is not a part of the three-dimensional shaped object. The predetermined shaping region in a certain powder layer includes an outline region constituting an outline and an infill region constituting an infill. The outline refers to a powder constituting a contour of the three-dimensional shaped object in the powder contained in the powder layer. That is, the outline region is a region filled with the powder constituting the contour of the three-dimensional shaped object in the powder contained in the powder layer. The infill refers to a powder constituting an inside of the three-dimensional shaped object in the powder contained in the powder layer. That is, the infill region is a region filled with the powder constituting the inside of the three-dimensional shaped object in the powder contained in the powder layer.

The binder contained in the first liquid X1 may be any binder that can bind individual particles contained in the powder P by melting. Examples of the binder contained in the first liquid X1 include acrylonitrile-butadiene-styrene (ABS), acrylonitrile-styrene-acrylate (ASA), polyethylene (PE), and paraffin wax, and are not limited thereto. In the following description, for example, a case where the binder is paraffin wax will be described. The binder contained in the first liquid X1 is preferably transparent, and may be translucent or opaque.

A liquid serving as a solvent or a dispersion medium of the binder in the first liquid X1 as described above may be any liquid capable of dissolving or dispersing the binder and vaporizing at a temperature lower than the melting point of the binder. More preferably, the liquid serving as the solvent or the dispersion medium of the binder in the first liquid X1 is vaporized at about room temperature in a room where the three-dimensional shaping apparatus 1 is provided. The room temperature is, for example, about 20° C. to 30° C. and is not limited thereto.

For example, when the body portion BX moves in the first direction and the second direction along the guide bar AX, the first dispensing unit 24A dispenses the first liquid X1 to at least the outline region in the shaping region of the powder layer in response to the request from the control unit 30.

The second supply unit 21B is a device that supplies the powder P downward. The second supply unit 21B is provided at a tail-side end portion of the body portion BX in the first direction. The second supply unit 21B includes a nozzle (not illustrated), and dispenses the powder P, which is supplied from the storage unit (not illustrated) that stores the powder P, downward from a tip of the nozzle. Accordingly, the second supply unit 21B can supply the powder P above the shaping surface 11A of the shaping table 11. For example, when the body portion BX moves in the second direction along the guide bar AX, the second supply unit 21B dispenses the powder P downward.

The second layer formation unit 22B is a member that forms the powder layer by smoothing the powder P supplied by the second supply unit 21B. The second layer formation unit 22B is provided adjacent to the second supply unit 21B in the first direction in the body portion BX. In the example illustrated in FIG. 1, the second layer formation unit 22B is a roller that rotates about a rotation shaft AX21, and forms the powder layer above the shaping surface 11A by pressing and smoothing the powder P supplied above the shaping surface 11A of the shaping table 11 from above. Instead of the roller, the second layer formation unit 22B may be another member capable of pressing and smoothing the powder P supplied above the shaping surface 11A of the shaping table 11 from above, such as a squeegee. The second layer formation unit 22B is supported by the second swinging unit 23B swingable about a predetermined swinging shaft AX22. More specifically, the rotation shaft AX21 of the second layer formation unit 22B is supported by the second swinging unit 23B swingable about the swinging shaft AX22. When the body portion BX moves in the second direction along the guide bar AX, the second layer formation unit 22B is located at a position where a lower end 22BT of the second layer formation unit 22B comes into contact with the virtual surface including the upper surface 10A of the table unit 10. In contrast, when the body portion BX moves in the first direction along the guide bar AX, the second layer formation unit 22B is located at a position where the lower end 22BT of the second layer formation unit 22B is separated upward from the surface. Such movement of the second layer formation unit 22B is implemented by the second swinging unit 23B.

The second swinging unit 23B is a rod-shaped member that supports the rotation shaft AX21 of the second layer formation unit 22B. The second swinging unit 23B can swing about the swinging shaft AX22 by an actuator (not illustrated) or the like. Accordingly, the second swinging unit 23B can separate the second layer formation unit 22B from the virtual surface including the upper surface 10A of the table unit 10.

The second dispensing unit 24B is a liquid dispensing device that dispenses a second liquid X2 containing at least the binder among the binder and the infrared absorber downward, and is, for example, a printer head having an adjustable dispensing amount of the second liquid X2 per unit time. In the following description, for example, a case where the binder contained in the second liquid X2 is the same as the binder contained in the first liquid X1 will be described. The binder contained in the second liquid X2 may be different from the binder contained in the first liquid X1. In the following description, for example, a case where the second liquid X2 does not include the infrared absorber will be described. Even when the second liquid X2 contains the infrared absorber, a content of the infrared absorber in the second liquid X2 is lower than a content of the infrared absorber in the first liquid X1. That is, in the present disclosure, a case where the content of the infrared absorber in the second liquid X2 is lower than the content of the infrared absorber in the first liquid X1 also includes a case where the second liquid X2 does not contain the infrared absorber. When the second liquid X2 contains the infrared absorber, the infrared absorber contained in the second liquid X2 may be the same as the infrared absorber contained in the first liquid X1, or may be different from the infrared absorber contained in the first liquid X1.

The second dispensing unit 24B is provided adjacent to the second layer formation unit 22B in the first direction in the body portion BX. The second dispensing unit 24B may be a printer head having an unadjustable dispensing amount of the second liquid X2 per unit time. The second dispensing unit 24B includes a plurality of nozzles (not illustrated) arranged in the first direction and a direction orthogonal to the gravity direction. In response to the request from the control unit 30, the second dispensing unit 24B dispenses the second liquid X2, which is supplied from a storage unit (not illustrated) that stores the second liquid X2, downward from at least a part of the plurality of nozzles. Accordingly, the second dispensing unit 24B can dispense the second liquid X2 to at least a part of a predetermined shaping region for each powder layer. The second dispensing unit 24B may be configured integrally with the first dispensing unit 24A.

For example, when the body portion BX moves in the first direction and the second direction along the guide bar AX, the second dispensing unit 24B dispenses the second liquid X2 to at least the outline region in the shaping region of the powder layer in response to the request from the control unit 30. In the following description, for convenience of description, when there is no need to distinguish between the first liquid X1 and the second liquid X2, the first liquid X1 and the second liquid X2 are collectively referred to as a liquid X.

The heating unit 25 is a heater that heats the powder layer to which at least one of the first liquid X1 or the second liquid X2 is dispensed. For example, the heating unit 25 is provided between the first dispensing unit 24A and the second dispensing unit 24B in the body portion BX. The heating unit 25 heats the powder layer at a predetermined heating temperature T. The heating at the heating temperature T by the heating unit 25 is performed to melt at least a part of the binder contained in a region to which the liquid X is dispensed in the powder layer, bind the individual particles contained in the powder P in the region by the binder, and promote evaporation of the liquid contained in the liquid X as the solvent or the dispersion medium of the binder. Therefore, the heating temperature T is lower than the boiling point of the binder and higher than the melting point of the binder. This is to melt the binder without evaporating the binder. This is because, in the shaping of the three-dimensional shaped object when the powder of the plant-derived fiber material is used as the powder P, the binder functions as a binding agent for binding the individual particles contained in the powder P as described above. In the following description, for example, a case is described where the heating temperature T is lower than the boiling point of the binder, higher than the melting point of the binder, and lower than a temperature at which thermal decomposition of the fiber material contained in the powder P occurs. That is, in the example, the heating temperature T is lower than the boiling point of the binder, higher than the melting point of the binder, and lower than the temperature at which the thermal decomposition of the lignocellulosic material contained in the powder P occurs. In this case, due to the heating by the heating unit 25, the three-dimensional shaping apparatus 1 can prevent unintended discoloration from occurring in the three-dimensional shaped object and a strength of the three-dimensional shaped object from being reduced. The temperature at which the thermal decomposition of the plant-derived fiber material occurs can be specified in advance by a preliminary experiment for each fiber material used as the powder P. That is, the temperature at which the thermal decomposition of the lignocellulosic material occurs can be specified in advance by the preliminary experiment. In the example, a melting point of paraffin wax, which is the binder, is about 70° C. In the example, the temperature at which the thermal decomposition of the lignocellulosic material, which is the plant-derived fiber material, occurs is about 150° C. Therefore, in the following description, for example, a case where the heating temperature T is 80° C. will be described. The heating unit 25 may be any heater that heats the powder layer to which at least one of the first liquid X1 or the second liquid X2 is dispensed. For example, depending on chamber temperature control methods, the heating unit 25 may be a heater that heats a region to which at least one of the first liquid X1 or the second liquid X2 is dispensed in the region of the powder layer and a region to which both the first liquid X1 and the second liquid X2 are not dispensed in the region of the powder layer, or may be a heater of another type.

The control unit 30 controls the table unit 10 and the shaping unit 20. As described above, the control unit 30 may not control the table unit 10.

The control unit 30 is, for example, a computer built in the three-dimensional shaping apparatus 1, and includes a processor such as a central processing unit (CPU) or a field programmable gate array (FPGA). The control unit 30 may include an input device that receives an operation from a user, a display device that displays an image, and a storage device that stores various types of information, or may operate in response to a request from another information processing apparatus communicably connected to the control unit 30 without including the input device and the display device. The control unit 30 is communicably connected to another information processing apparatus. In the example illustrated in FIG. 1, the control unit 30 is communicably connected to the external apparatus 40 which is an example of another information processing apparatus. The control unit 30 may be integrated with the external apparatus 40.

The external apparatus 40 is, for example, an information processing apparatus such as a workstation, a desktop personal computer (PC), a notebook PC, a tablet PC, a multifunctional mobile phone terminal (smartphone), a mobile phone terminal, or a personal digital assistant (PDA) and is not limited thereto. For example, the external apparatus 40 generates shaping data on the three-dimensional shaped object shaped by the three-dimensional shaping apparatus 1 according to the received operation. The external apparatus 40 outputs the generated shaping data to the control unit 30 according to the received operation. In addition, the external apparatus 40 outputs various requests to the control unit 30, such as a request for the three-dimensional shaping apparatus 1 to start shaping the three-dimensional shaped object.

The three-dimensional shaping apparatus 1 configured as described above stacks the N powder layers above the shaping surface 11A of the shaping table 11 while reciprocating the body portion BX of the shaping unit 20 along the guide bar AX. For example, the three-dimensional shaping apparatus 1 sequentially supplies the powder P by the second supply unit 21B, forms the powder layer by the second layer formation unit 22B, dispenses the second liquid X2 by the second dispensing unit 24B, and dispenses the first liquid X1 by the first dispensing unit 24A while moving the body portion BX in the second direction along the guide bar AX. Thereafter, the three-dimensional shaping apparatus 1 heats the powder layer by the heating unit 25. Further, for example, the three-dimensional shaping apparatus 1 sequentially supplies the powder P by the first supply unit 21A, forms the powder layer by the first layer formation unit 22A, dispenses the first liquid X1 by the first dispensing unit 24A, and dispenses the second liquid X2 by the second dispensing unit 24B while moving the body portion BX in the first direction along the guide bar AX. Thereafter, the three-dimensional shaping apparatus 1 heats the powder layer by the heating unit 25. Accordingly, the three-dimensional shaping apparatus 1 can stack the N powder layers above the shaping surface 11A of the shaping table 11 while reciprocating the body portion BX back and forth in the first direction along the guide bar AX. The three-dimensional shaping apparatus 1 may heat the powder layer by the heating unit 25 while moving the body portion BX, or may heat the powder layer by the heating unit 25 without moving the body portion BX. In the following description, for example, a case where the three-dimensional shaping apparatus 1 heats the powder layer by the heating unit 25 without moving the body portion BX will be described. In this case, for example, the heating unit 25 heats the powder layer at the heating temperature T by setting a temperature in a space in which the powder layer is formed to the heating temperature T in a space of the three-dimensional shaping apparatus 1. In other words, in this case, the heating unit 25 is a heater of the above-described chamber temperature control method.

In this way, the three-dimensional shaping apparatus 1 repeats at least the first step and the second step among the three steps including the first step, the second step, and the third step to shape the three-dimensional shaped object. The first step is supplying the powder P to form the powder layer above the shaping surface 11A on which the three-dimensional shaped object is to be shaped. The second step is dispensing at least one of the first liquid X1 or the second liquid X2 to at least a part of the powder layer formed in the first step. The third step is heating the powder layer to which at least one of the first liquid X1 or the second liquid X2 is dispensed in the second step at the heating temperature T. Specifically, the three-dimensional shaping apparatus 1 shapes the three-dimensional shaped object by repeating the first step, the second step, and the third step in an order of the first step, the second step, and the third step. Accordingly, for example, the three-dimensional shaping apparatus 1 can form the multicolor texture at the surface of the three-dimensional shaped object by changing a ratio of the dispensing amount of the first liquid X1 and the dispensing amount of the second liquid X2 for each region to which the liquid X is dispensed in the powder layer. As a result, the three-dimensional shaping apparatus 1 can form a desired texture at the surface of the three-dimensional shaped object without increasing the number of members that dispense the liquid X. In the following description, for convenience of description, a step that includes the first step, the second step, and the third step and in which the first step, the second step, and the third step are repeated in the order of the first step, the second step, and the third step will be described as the shaping step.

The three-dimensional shaping apparatus 1 may heat the N powder layers by the heating unit 25 after the N powder layers are stacked on the shaping surface 11A. In this case, the three-dimensional shaping apparatus 1 repeats the first step and the second step in the order of the first step and the second step, and then performs the third step to shape the three-dimensional shaped object. That is, the shaping step may be a step of repeating the first step and the second step in the order of the first step and the second step and then performing the third step to shape the three-dimensional shaped object. In this case as well, for example, the three-dimensional shaping apparatus 1 can form the multicolor texture at the surface of the three-dimensional shaped object by changing the ratio of the dispensing amount of the first liquid X1 and the dispensing amount of the second liquid X2 for each region to which the liquid X is dispensed in the powder layer. As a result, the three-dimensional shaping apparatus 1 can form a desired texture at the surface of the three-dimensional shaped object without increasing the number of members that dispense the liquid X.

Here, the user of the three-dimensional shaping apparatus 1 may perform a heating step of heating the three-dimensional shaped object shaped by the three-dimensional shaping apparatus 1 at a predetermined second heating temperature after the three-dimensional shaped object is shaped by the three-dimensional shaping apparatus 1. The second heating temperature may be any temperature lower than the boiling point of the binder, higher than the heating temperature T, and lower than the temperature at which the thermal decomposition of the lignocellulosic material occurs. This is because the heating step is performed to improve the strength of the three-dimensional shaped object after being heated by the heating step by melting the binder that is not melted by being heated at the heating temperature T in the binder contained in the three-dimensional shaped object. The three-dimensional shaping method performed by the user can improve the strength of the three-dimensional shaped object when including such a heating step in addition to the shaping step.

In addition, the user of the three-dimensional shaping apparatus 1 may perform an impregnation step of impregnating the three-dimensional shaped object in a resin after performing the shaping step or after performing the shaping step and the heating step in an order of the shaping step and the heating step. The impregnation step is a step of improving the strength of the three-dimensional shaped object. The three-dimensional shaping method performed by the user can more reliably improve the strength of the three-dimensional shaped object when including such an impregnation step in addition to the shaping step or the shaping step and the heating step.

Examples of the resin for impregnating the three-dimensional shaped object in the impregnation step include a urethane resin, an epoxy resin, a phenol resin, alkylated methylol melamine, glycouryl, a methyl urea resin, a methylol resin, and a glycoluril, and are not limited thereto.

### Method for Dispensing Each of First Liquid X1 and Second Liquid X2

Here, a method for dispensing each of the first liquid X1 and the second liquid X2 by the three-dimensional shaping apparatus 1 will be described.

The above-described shaping data includes data indicating the shaping region provided in the powder layer for each powder layer. The data further includes data indicating each of M types of regions provided in the outline region of the shaping region. Here, the M may be any integer of 2 or more. The M types of regions are regions having different colors and can be arranged in an ascending order of brightness from a first type of region toward an M-th type of region. That is, a brightness of an (m-1)-th type of region among the M types of regions is lower than a brightness of an m-th type of region among the M types of regions. The m is any integer within a range of 2 or more and M or less. The brightness of the m-th type of region among the M types of regions provided in a certain powder layer is a brightness of the m-th type of region after the powder layer is heated by the heating unit 25 at the heating temperature T.

For example, when the liquid X is dispensed to each of the M types of regions provided in a certain powder layer, the three-dimensional shaping apparatus 1 dispenses the liquid X having a predetermined dispensing amount to each of the M types of regions. However, the three-dimensional shaping apparatus 1 changes the ratio of the dispensing amount of the first liquid X1 and the dispensing amount of the second liquid X2 for each of the M types of regions. Specifically, the ratio of the dispensing amount of the first liquid X1 and the dispensing amount of the second liquid X2 is a value obtained by dividing the dispensing amount of the second liquid X2 by the dispensing amount of the first liquid X1. When the liquid X is dispensed to the m-th type of region among the M types of regions, the three-dimensional shaping apparatus 1 dispenses the first liquid X1 and the second liquid X2 to the m-th type of region such that the ratio of the dispensing amount of the first liquid X1 and the dispensing amount of the second liquid X2 is a ratio corresponding to the m-th type of region. Here, a ratio associated with the (m-1)-th type of region among the M types of regions is smaller than the ratio associated with the m-th type of region among the M types of regions. This is because, when the liquid X is dispensed to a certain region, a brightness of the region increases as the dispensing amount of the second liquid X2 to the region increases with respect to the dispensing amount of the first liquid X1 to the region. This is because carbon, which is an example of the infrared absorber in this example, contributes to a direction in which the brightness of the region is lowered. A ratio indicating infinity may be associated with the m-th type of region among the M types of regions. In this case, the first liquid X1 is not dispensed to the m-th type of region. Further, a ratio indicating 0 may be associated with the first-type of region among the M types of regions. In this case, the second liquid X2 is not dispensed to the first-type of region. In addition, as in this example, when carbon is the infrared absorber, since carbon is unlikely to induce deterioration of the powder P, the three-dimensional shaping apparatus 1 can prevent the strength of the three-dimensional shaped object from being reduced. The infrared absorber may be a powder using aluminum, iron, polycyclic aromatic hydrocarbon, or the like as a main component instead of carbon.

In this way, the three-dimensional shaping apparatus 1 can set a different brightness to each of the M types of regions provided in each of the N powder layers. The difference in brightness is recognized as a different in color by a human. That is, the three-dimensional shaping apparatus 1 can form the multicolor texture at the surface of the three-dimensional shaped object. As a result, the three-dimensional shaping apparatus 1 can form a desired texture at the surface of the three-dimensional shaped object without increasing the number of members that dispense the liquid X. For example, the three-dimensional shaping apparatus 1 can form a texture having a gradation such as a grain as a desired texture at the surface of the three-dimensional shaped object.

The number of the M types of regions provided in a part or all of the N powder layers may be different or may be the same.

Further, the three-dimensional shaping apparatus 1 may dispense the liquid X to the infill region, or may not dispense the liquid X to the infill region. When the liquid X is not dispensed to the infill region, that is, when the infill region does not include the above-described M types of regions, the three-dimensional shaping apparatus 1 can prevent the deterioration of the powder P inside the three-dimensional shaped object. As a result, it is possible to prevent the strength of the three-dimensional shaped object from being reduced.

### Flow of Three-Dimensional Shaping Method

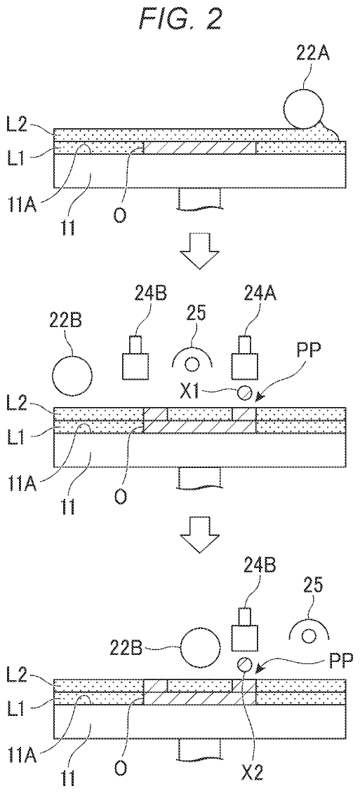

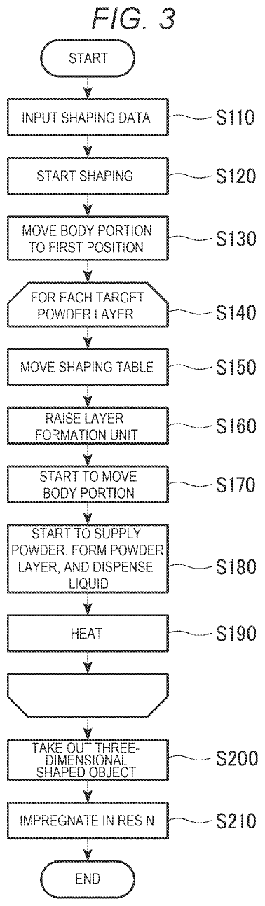

In the following description, an example of a flow of the three-dimensional shaping method according to the embodiment will be described with reference to FIGS. 2 and 3. FIG. 2 is a diagram illustrating an example of a state in which the shaping unit 20 forms the powder layer L2 among the four powder layers illustrated in FIG. 1. FIG. 3 is a diagram illustrating an example of the flow of the three-dimensional shaping method in which the user shapes the three-dimensional shaped object by using the three-dimensional shaping apparatus 1.

The user operates the external apparatus 40 to input the shaping data on the three-dimensional shaped object to be shaped by the three-dimensional shaping apparatus 1 to the control unit 30 of the three-dimensional shaping apparatus 1 (step S110). The user may input the shaping data to the control unit 30 by using an apparatus other than the external apparatus 40.

Next, the user operates the external apparatus 40 and causes the three-dimensional shaping apparatus 1 to start the shaping of the three-dimensional shaped object based on the shaping data input to the control unit 30 in step S110 (step S120). Accordingly, in step S130 to step S190, the three-dimensional shaping apparatus 1 controls the table unit 10 and the shaping unit 20 to execute the above-described shaping step. That is, the user executes the shaping step by starting to shape the three-dimensional shaped object based on the shaping data in the three-dimensional shaping apparatus 1.

First, the control unit 30 of the three-dimensional shaping apparatus 1 moves the body portion BX of the shaping unit 20 to a predetermined first position along the guide bar AX (step S130). The first position is a predetermined position as a position at which the body portion BX is located immediately before the shaping step is started among positions at which the body portion BX can be located, and is, for example, a position closest to a first direction side among positions at which the body portion BX can move along the guide bar AX. The first position may be a position in front of the position closest to the first direction side among the positions at which the body portion BX can move along the guide bar AX. However, when the three-dimensional shaping apparatus 1 is viewed in the gravity direction, the second supply unit 21B of the body portion BX located at the first position does not overlap the shaping surface 11A of the shaping table 11, and is located on the first direction side relative to the shaping surface 11A. In step S130, the control unit 30 may move the body portion BX to a predetermined second position along the guide bar AX. The second position is, for example, a position closest to a second direction side among the positions at which the body portion BX can move along the guide bar AX. The second position may be a position in front of the position closest to the second direction side among the positions at which the body portion BX can move along the guide bar AX. However, when the three-dimensional shaping apparatus 1 is viewed in the gravity direction, the first supply unit 21A of the body portion BX located at the second position does not overlap the shaping surface 11A of the shaping table 11, and is located on the second direction side relative to the shaping surface 11A.

Next, based on the shaping data input in step S110, the control unit 30 selects the N powder layers stacked above the shaping surface 11A of the shaping table 11 one by one from the bottom as a target powder layer to be formed, and repeats processing in step S150 to step S190 for each selected target powder layer (step S140).

The control unit 30 specifies data on the target powder layer selected in step S140 from data provided in the shaping data input in step S110. Then, the control unit 30 controls the table unit 10 based on the specified data, and moves the shaping table 11 such that the shaping surface 11A is located below the upper surface 10A of the table unit 10 by a thickness of the target powder layer (step S150).

Next, the control unit 30 raises either the first layer formation unit 22A or the second layer formation unit 22B (step S160). Specifically, when a position of the body portion BX is the first position, the control unit 30 controls the first swinging unit 23A to raise the first layer formation unit 22A in step S160. At this time, when the second layer formation unit 22B is raised, the control unit 30 controls the second swinging unit 23B to lower the second layer formation unit 22B. In step S160, when the position of the body portion BX is the first position and the first layer formation unit 22A is lowered, the control unit 30 does not control the first swinging unit 23A. In contrast, when the position of the body portion BX is the second position, the control unit 30 controls the second swinging unit 23B to move the second layer formation unit 22B in step S160. At this time, when the first layer formation unit 22A is raised, the control unit 30 controls the first swinging unit 23A to lower the first layer formation unit 22A. In step S160, when the position of the body portion BX is the second position and the second layer formation unit 22B is lowered, the control unit 30 does not control the second swinging unit 23B.

Next, the control unit 30 starts to move the body portion BX along the guide bar AX (step S170). In step S170, when the position of the body portion BX is the first position, the control unit 30 starts to move the body portion BX in the second direction toward the second position along the guide bar AX. In contrast, in step S170, when the position of the body portion BX is the second position, the control unit 30 starts to move the body portion BX in the first direction toward the first position along the guide bar AX.

Next, the control unit 30 causes one of the first supply unit 21A and the second supply unit 21B to start supplying the powder P above the shaping surface 11A, causes one of the first layer formation unit 22A and the second layer formation unit 22B to start forming the target powder layer, causes the first dispensing unit 24A to start dispensing the first liquid X1, and causes the second dispensing unit 24B to start dispensing the second liquid X2 (step S180). Specifically, when the body portion BX starts moving toward the second position in step S170, in step S180, the control unit 30 causes the second supply unit 21B to start dispensing the powder P and prohibits the first supply unit 21A from dispensing the powder P. In this case, in step S180, the control unit 30 causes the second layer formation unit 22B to start forming the target powder layer by smoothing the powder P dispensed by the second supply unit 21B. In this case, in step S180, the control unit 30 causes the first dispensing unit 24A to start dispensing the first liquid X1 to the outline region of the target powder layer formed by the second layer formation unit 22B while causing the second dispensing unit 24B to start dispensing the second liquid X2 to the outline region. In contrast, when the body portion BX starts moving toward the first position in step S170, in step S180, the control unit 30 causes the first supply unit 21A to start dispensing the powder P and prohibits the second supply unit 21B from dispensing the powder P. In this case, in step S180, the control unit 30 causes the first layer formation unit 22A to start forming the target powder layer by smoothing the powder P dispensed by the first supply unit 21A. In this case, in step S180, the control unit 30 causes the second dispensing unit 24B to start dispensing the second liquid X2 to the outline region of the target powder layer formed by the first layer formation unit 22A while causing the first dispensing unit 24A to start dispensing the first liquid X1 to the outline region. Then, after the dispensing of the liquid X to the target powder layer ends, the control unit 30 moves the body portion BX to a position closer to the body portion BX among the first position and the second position to stop the body portion BX.

Next, the control unit 30 controls the heating unit 25 to heat the target powder layer at the heating temperature T (step S190). Here, for example, in step S190, the control unit 30 continues heating the target powder layer at the heating temperature T until a predetermined heating time elapses from a timing at which the heating by the heating unit 25 is started. Then, after the heating time elapses from the timing, the control unit 30 proceeds to step S140 and selects a next target powder layer. When there is no powder layer which is not selected as the target powder layer in step S140, the control unit 30 ends the repetition processing in step S140 to step S190 and proceeds to step S200.

Here, the state diagram in an upper part of FIG. 2 illustrates an example of a state in which the powder P supplied by the first supply unit 21A is smoothed and the powder layer L2 is formed by the first layer formation unit 22A as the target powder layer in step S180 when the body portion BX moves in the first direction. In this case, as illustrated in the state diagram, the second layer formation unit 22B is raised by the second swinging unit 23B in step S160 and does not come into contact with the powder P.

In this way, the powder layer L2 is formed by the first layer formation unit 22A. The first dispensing unit 24A, which moves in the first direction to follow the first layer formation unit 22A according to the movement of the body portion BX, dispenses the first liquid X1 as illustrated in the state diagram in a middle part of FIG. 2 to at least a part of the shaping region of the powder layer L2 formed by the first layer formation unit 22A in this way. The state diagram in the middle part of FIG. 2 is a diagram illustrating an example of a state in which the first dispensing unit 24A dispenses the first liquid X1 to the outline region of the powder layer L2 formed by the second layer formation unit 22B. A region PP illustrated in the state diagram in the middle part of FIG. 2 illustrates an example of the outline region provided in the powder layer L2. The dispensing amount of the first liquid X1 dispensed from the first dispensing unit 24A to the region PP is calculated by the control unit 30 based on a ratio corresponding to a region including the region PP among the M types of regions provided in the outline region provided in the powder layer L2.

Then, the second dispensing unit 24B, which moves in the first direction to follow the first layer formation unit 22A according to the movement of the body portion BX, dispenses the second liquid X2 as illustrated in the state diagram in a lower part of FIG. 2 to at least a part of the shaping region of the powder layer L2 formed by the first layer formation unit 22A. The state diagram in the lower part of FIG. 2 is a diagram illustrating an example of a state in which the second dispensing unit 24B dispenses the second liquid X2 to the outline region of the powder layer L2 formed by the second layer formation unit 22B. In the state diagram, the second dispensing unit 24B dispenses the second liquid X2 to the above-described region PP. The dispensing amount of the second liquid X2 dispensed from the second dispensing unit 24B to the region PP is calculated by the control unit 30 based on the ratio corresponding to the region including the region PP among the M types of regions provided in the outline region provided in the powder layer L2.

In this way, the user can perform the shaping step by causing the three-dimensional shaping apparatus 1 to perform the processing in step S130 to step S190. That is, the user can cause the three-dimensional shaping apparatus 1 to shape the three-dimensional shaped object by causing the three-dimensional shaping apparatus 1 to perform the processing in step S130 to step S190. The user may perform the shaping step by using another apparatus instead of performing the shaping step by using the three-dimensional shaping apparatus 1.

After the repetition processing in step S140 to step S190 is ended, the user takes out the three-dimensional shaped object, which is shaped by the three-dimensional shaping apparatus 1 through the processing in step S130 to step S190, from the three-dimensional shaping apparatus 1 (step S200). At this time, the user removes a powder other than the powder P bound by the binder as the three-dimensional shaped object by discarding the powder into, for example, a collection box.

After the three-dimensional shaped object is shaped in step S200, the user cools the three-dimensional shaped object after shaping. Then, the user performs the impregnation step of impregnating the cooled three-dimensional shaped object in the resin (step S210). For example, in step S210, the user impregnates the three-dimensional shaped object in the resin by putting the three-dimensional shaped object into a resin tank filled with a predetermined type of resin. The user may impregnate the three-dimensional shaped object in the resin by another method. In a flowchart illustrated in FIG. 3, a process in step S210 may be omitted.

After impregnating the three-dimensional shaped object in the resin in step S210, the user ends processes of the flowchart illustrated in FIG. 3, and ends the shaping of the three-dimensional shaped object by the three-dimensional shaping method according to the embodiment.

In step S180, when the position of the body portion BX is the second position, the three-dimensional shaping apparatus 1 may form the target powder layer by the first supply unit 21A and the first layer formation unit 22A while moving the body portion BX in the first direction, and then dispense the liquid X to at least a part of the shaping region of the target powder layer by the first dispensing unit 24A and the second dispensing unit 24B while moving the body portion BX in the second direction. In this case, the three-dimensional shaping apparatus 1 may have a configuration in which a speed at which the body portion BX moves in the first direction, that is, a moving speed of the first layer formation unit 22A is slower than a speed at which the body portion BX moves in the second direction, that is, a moving speed of the first dispensing unit 24A and the second dispensing unit 24B. In step S180, when the position of the body portion BX is the first position, the three-dimensional shaping apparatus 1 may form the target powder layer by the second supply unit 21B and the second layer formation unit 22B while moving the body portion BX in the second direction, and then dispense the liquid X to at least a part of the shaping region of the target powder layer by the first dispensing unit 24A and the second dispensing unit 24B while moving the body portion BX in the first direction. In this case, the three-dimensional shaping apparatus 1 may have a configuration in which the speed at which the body portion BX moves in the second direction, that is, the moving speed of the second layer formation unit 22B is slower than the speed at which the body portion BX moves in the first direction, that is, the moving speed of the first dispensing unit 24A and the second dispensing unit 24B. Accordingly, the three-dimensional shaping apparatus 1 can prevent the powder P from flying up before the liquid X is dispensed due to wind generated by the movement of the body portion BX. A moving speed of the second layer formation unit 22B may be the same as the moving speed of the first dispensing unit 24A and the second dispensing unit 24B, or may be faster than the moving speed of the first dispensing unit 24A and the second dispensing unit 24B. Further, the moving speed of the first layer formation unit 22A may be the same as the moving speed of the first dispensing unit 24A and the second dispensing unit 24B, or may be faster than the moving speed of the first dispensing unit 24A and the second dispensing unit 24B.

In this way, the three-dimensional shaping method executed by the three-dimensional shaping apparatus 1 is a three-dimensional shaping method for shaping a three-dimensional shaped object, and includes: a shaping step of shaping the three-dimensional shaped object by repeating at least a first step and a second step among three steps including the first step, the second step, and a third step. The first step is supplying a powder P to form a powder layer on a shaping surface 11A at which the three-dimensional shaped object is to be shaped. The second step is dispensing at least one of a first liquid X1 or a second liquid X2 to at least a part of the powder layer formed in the first step, the first liquid X1 containing both a binder and an infrared absorber, the second liquid X2 containing at least the binder among the binder and the infrared absorber. The third step is heating the powder layer to which at least one of the first liquid X1 or the second liquid X2 is dispensed in the second step at a predetermined heating temperature T. The heating temperature T is lower than a boiling point of the binder and higher than a melting point of the binder. A content of the infrared absorber in the second liquid X2 is lower than a content of the infrared absorber in the first liquid X1. Accordingly, in the three-dimensional shaping method, for example, the multicolor texture can be formed at the surface of the three-dimensional shaped object by changing a ratio of an amount of the dispensed first liquid X1 and an amount of the dispensed second liquid X2 for each region at which the liquid X is dispensed in the powder layer. As a result, the three-dimensional shaping apparatus 1 can form a desired texture at the surface of the three-dimensional shaped object without increasing the number of members that dispense the liquid X.

In the three-dimensional shaping method described above, the heating temperature T may be equal to or higher than the temperature at which the thermal decomposition of the plant-derived fiber material occurs. In this case, in the three-dimensional shaping method, the multicolor texture can be formed at the surface of the three-dimensional shaped object by using discoloration of the powder layer caused by the thermal decomposition of the fiber material. However, in this case, the user needs to specify information indicating a correlation between a time for heating the powder layer at the heating temperature T and a color of the powder layer after being heated by experiments or the like in advance. When the information is specified, the user can designate the time for heating the powder layer at the heating temperature T based on the shaping data in the three-dimensional shaping apparatus 1, and can form a texture having more various colors at the surface of the three-dimensional shaped object by using the three-dimensional shaping apparatus 1.

Further, the contents described above may be combined in any manner.

### APPENDIX

[1] A three-dimensional shaping method for shaping a three-dimensional shaped object, the three-dimensional shaping method including: a shaping step of shaping the three-dimensional shaped object by repeating at least a first step and a second step among three steps including the first step, the second step, and a third step, the first step being supplying a powder containing a plant-derived fiber material to form a powder layer above a shaping surface at which the three-dimensional shaped object is to be shaped, the second step being dispensing at least one of a first liquid or a second liquid to at least a part of the powder layer formed in the first step, the first liquid containing both a binder and an infrared absorber, the second liquid containing at least the binder among the binder and the infrared absorber, the third step being heating the powder layer to which at least one of the first liquid or the second liquid is dispensed in the second step at a predetermined heating temperature, in which the heating temperature is lower than a boiling point of the binder and higher than a melting point of the binder, and a content of the infrared absorber in the second liquid is lower than a content of the infrared absorber in the first liquid.

[2] The three-dimensional shaping method according to [1], in which the shaping step is a step of shaping the three-dimensional shaped object by repeating the first step, the second step, and the third step in an order of the first step, the second step, and the third step.

[3] The three-dimensional shaping method according to [1], in which the shaping step is a step of shaping the three-dimensional shaped object by repeating the first step and the second step in an order of the first step and the second step and then performing the third step.

[4] The three-dimensional shaping method according to any one of [1] to [3], further including: an impregnation step of impregnating the three-dimensional shaped object after shaping in a resin.

[5] The three-dimensional shaping method according to any one of [1] to [4], in which the infrared absorber contains carbon.

[6] The three-dimensional shaping method according to any one of [1] to [5], in which the heating temperature is lower than a temperature at which thermal decomposition of the fiber material occurs.

[7] The three-dimensional shaping method according to [6], in which the powder layer includes a shaping region that is at least a part of the three-dimensional shaped object and a non-shaping region that is not a part of the three-dimensional shaped object, and the shaping region includes a first region to which the first liquid is dispensed and a second region to which the second liquid is dispensed.

[8] The three-dimensional shaping method according to [7], in which the shaping region includes an outline region constituting an outline and an infill region constituting an infill, the outline region includes the first region and the second region, and the infill region does not include the first region or the second region.

[9] The three-dimensional shaping method according to any one of [1] to [8], in which the first step is a step of forming the powder layer above the shaping surface by moving a layer formation unit parallel to the shaping surface, the second step is a step of dispensing at least one of the first liquid or the second liquid to the powder layer by a liquid dispensing unit configured to dispense each of the first liquid and the second liquid and move above the powder layer in parallel to the shaping surface, and a moving speed of the layer formation unit in the first step is slower than a moving speed of the liquid dispensing unit in the second step.

[10] The three-dimensional shaping method according to [9], in which the layer formation unit is a roller or a squeegee.

[11] The three-dimensional shaping method according to [9] or [10], in which the liquid dispensing unit is a printer head.

[12] A three-dimensional shaping apparatus for shaping a three-dimensional shaped object, the three-dimensional shaping apparatus including: a shaping table having a shaping surface for shaping the three-dimensional shaped object; a layer formation unit configured to form a powder layer of a powder containing a plant-derived fiber material above the shaping surface; a dispensing unit configured to dispense at least one of a first liquid or a second liquid to at least a part of the powder layer formed by the layer formation unit, the first liquid containing both a binder and an infrared absorber, the second liquid containing at least the binder among the binder and the infrared absorber; a heating unit configured to heat the powder layer to which at least one of the first liquid or the second liquid is dispensed by the dispensing unit; and a control unit configured to control the dispensing unit, the layer formation unit, and the heating unit, in which the control unit heats the powder layer at a predetermined heating temperature when the powder layer is heated by the heating unit, the heating temperature is lower than a boiling point of the binder and higher than a melting point of the binder, and a content of the infrared absorber in the second liquid is lower than a content of the infrared absorber in the first liquid.

Although the embodiment of the present disclosure is described in detail with reference to the drawings, a specific configuration is not limited to the embodiment and may be changed, replaced, deleted, or the like without departing from the gist of the present disclosure.

Further, a program for implementing a function of any component in the apparatus described above may be recorded in a computer-readable recording medium, and the program may be read and executed by a computer system. Here, the apparatus is, for example, the three-dimensional shaping apparatus 1, the external apparatus 40, or the like. Here, the term “computer system” includes an operating system (OS) and hardware such as peripheral devices. The “computer-readable recording medium” refers to a storage device such as a portable medium such as a flexible disk, a magneto-optical disk, a ROM, and a compact disk (CD) ROM, and a hard disk built in the computer system. Further, the “computer-readable recording medium” includes a medium that stores the program for a certain period of time, such as a volatile memory inside the computer system serving as a server or a client when the program is transmitted via a network such as the Internet or a communication line such as a telephone line.

The program may be transmitted from the computer system in which the program is stored in the storage device to another computer system via a transmission medium or a transmission wave in the transmission medium. Here, the “transmission medium” for transmitting the program refers to a medium having a function of transmitting information such as a network such as the Internet or a communication line such as a telephone line.

The program may be a program for implementing a part of the functions described above. Further, the program may be a so-called difference file or a differential program for implementing the above-described functions in combination with the program recorded in the computer system.

What is claimed is:

1. A three-dimensional shaping method for shaping a three-dimensional shaped object, the three-dimensional shaping method comprising:
a shaping step of shaping the three-dimensional shaped object by repeating at least a first step and a second step among three steps including the first step, the second step, and a third step,
the first step being supplying a powder containing a plant-derived fiber material to form a powder layer above a shaping surface at which the three-dimensional shaped object is to be shaped,
the second step being dispensing at least one of a first liquid or a second liquid to at least a part of the powder layer formed in the first step, the first liquid containing both a binder and an infrared absorber, the second liquid containing at least the binder among the binder and the infrared absorber,
the third step being heating the powder layer to which at least one of the first liquid or the second liquid is dispensed in the second step at a predetermined heating temperature, wherein
the heating temperature is lower than a boiling point of the binder and higher than a melting point of the binder, and
a content of the infrared absorber in the second liquid is lower than a content of the infrared absorber in the first liquid.

2. The three-dimensional shaping method according to claim 1, wherein
the shaping step is a step of shaping the three-dimensional shaped object by repeating the first step, the second step, and the third step in an order of the first step, the second step, and the third step.

3. The three-dimensional shaping method according to claim 1, wherein
the shaping step is a step of shaping the three-dimensional shaped object by performing the third step after repeating the first step and the second step in an order of the first step and the second step.

4. The three-dimensional shaping method according to claim 1, further comprising:
an impregnation step of impregnating the three-dimensional shaped object after shaping in a resin.

5. The three-dimensional shaping method according to claim 1, wherein
the infrared absorber contains carbon.

6. The three-dimensional shaping method according to claim 5, wherein
the heating temperature is lower than a temperature at which thermal decomposition of the fiber material occurs.

7. The three-dimensional shaping method according to claim 1, wherein
the powder layer includes a shaping region that is at least a part of the three-dimensional shaped object and a non-shaping region that is not a part of the three-dimensional shaped object, and
the shaping region includes a first region to which the first liquid is dispensed and a second region to which the second liquid is dispensed.

8. The three-dimensional shaping method according to claim 7, wherein
the shaping region includes an outline region constituting an outline and an infill region constituting an infill,
the outline region includes the first region and the second region, and
the infill region does not include the first region or the second region.

9. The three-dimensional shaping method according to claim 1, wherein
the first step is a step of forming the powder layer above the shaping surface by moving a layer formation unit parallel to the shaping surface,
the second step is a step of dispensing at least one of the first liquid or the second liquid to the powder layer by a liquid dispensing unit configured to dispense each of the first liquid and the second liquid and move above the powder layer in parallel to the shaping surface, and
a moving speed of the layer formation unit in the first step is slower than a moving speed of the liquid dispensing unit in the second step.

10. The three-dimensional shaping method according to claim 9, wherein
the layer formation unit is a roller or a squeegee.

11. The three-dimensional shaping method according to claim 9, wherein
the liquid dispensing unit is a printer head.
